(19) United States
(12) Patent Application Publication
(10) Pub. No.: US 2013/0216446 A1
(43) Pub. Date: Aug. 22, 2013

(54) CONTAINMENT VESSEL AND SCALE-UP METHOD FOR CHEMICAL PROCESSES

(71) Applicant: William Rex Clingan, St. Paul, MO (US)

(72) Inventor: William Rex Clingan, St. Paul, MO (US)

(21) Appl. No.: 13/774,600

(22) Filed: Feb. 22, 2013

Related U.S. Application Data
(60) Provisional application No. 61/601,631, filed on Feb. 22, 2012.

(51) Int. Cl. B01J 19/24

(52) U.S. Cl. CPC B01J 19/24
USPC 422/198; 422/129; 29/401.1; 137/1

(57) ABSTRACT

A process container for use in a chemical process comprising two planar faces parallel to each other wherein the edges of the faces are joined together by adjacent curved bullnose portions. The process of scaling up a chemical process operation from a small scale apparatus to a large scale unit comprising the steps of: maintaining the diameter of the small scale apparatus as a critical dimension; inserting a rectangularly cross-sectioned extension between two half-cylindrically shaped ends corresponding to halves of the apparatus.

The present application claims priority to U.S. Patent Application No. 61/601,631, filed Feb. 22, 2012, entitled Containment Vessel and Scale-Up Method For Chemical Processes, the disclosures of which are hereby incorporated by reference in their entirety.

### TECHNICAL FIELD

The disclosure relates generally to a containment vessel used in chemical processing. More specifically, the present disclosure relates to the scale-up and design of process equipment.

### BACKGROUND

Chemical manufacture relies on the use of small-scale experimentation to predict large-scale performance. The first requirement for a piece of processing equipment is that it function as a container, to isolate the materials processed from the environment. Spherical, cylindrical, and conical geometries have historically dominated as the shapes in which material containers are constructed. Specifically, cylinders of low aspect ratio deriving from cooking pots and pans, and cylinders of high aspect ratio deriving from piping used for transport and conveying material are the predominant containers chemical processes are conducted in.

The best approach to the scale-up of chemical processes is generally regarded to be to scale down from intended large-scale equipment to the smallest geometrically similar apparatus in which experimentation can be performed. One problem with this approach is that the commercially available and practiced equipment types were virtually all scaled up from small units in the conventional pot and pipe shapes. Focusing on chemical reactions as the heart of most chemical processes, the flasks and beakers employed on the laboratory scale are spherical, cylindrical, or conical. As solid surfaces of rotation, these are symmetric about at least one axis, and lend themselves to containment of fluid and solid mixtures in motion imparted by rotating shafts.

Those skilled in the art of scale-up insist on cylindrical geometry in preference to the spherical geometry of the chemists' round-bottomed flask, because process results determined by the swirling flow in such containers scales up very poorly. A theoretical basis for this has recently shown that the maximum scale factor in any dimension that maintains the same eddy structure is approximately 3.

In the field of chemical reaction engineering, the three fundamental, ideal reactor types—the batch stirred tank reactor, the continuous stirred tank reactor, and the tubular or plug flow reactor are all cylindrical. The scale-up of cylindrical reactors follows one of three methods: increase diameter, increase length, and increase the number of reactors operating in parallel (often referred to as scale-out). The preference for geometric similarity in scale-up as a first resort is a combination of increase of diameter and increase of length by similar ratios.

The requirement of operation of a 10% scale demonstration facility to be considered for a recent US Department of Energy loan guarantee program for advanced biofuels is indicative of the state of scale-up in the chemical process industries. Similarly, the claims made by designers, manufacturers, and integrators of chemical process equipment regarding expertise in the challenging task of scale-up highlights the needs in this area

The adoption of the cylinder as the default and rarely departed from geometry for chemical process equipment appears to date from the days when the simplification of the mathematics needed to describe the physics taking place within the process container and its physical shell was justifiable in savings of effort hours spent working with tables of logarithms and later slide rules. It is hardly justified in the current era in which the average cell phone offers greater computing power than many generations of the most powerful computers available. Vast computing and manpower resources are currently devoted through computational fluid dynamics and similar advanced computation techniques to the study of the poor large scale performance attendant with continued reliance on cylindrical geometry.

There have been very few attempts to depart from the cylindrical geometry for process containers and for the scale-up of chemical processes. Known process containers and reactors that are non-cylindrical in shape include rectangular shaped reactors, slot reaction chambers, octagonal geometry reactors, and toroidal shaped reactors. These known non-cylindrical shapes however, have several drawbacks. For example, these known vessels are limited to essentially atmospheric operation and are only suitable for certain applications. These vessels also suffer from the same difficulties related to scale-up described above.

There are many difficulties in the scale-up of process equipment from the laboratory or pilot plant. For example, changing the scale of a reaction alters the heat removal and mixing characteristics of the reaction zone, which may result in differences in temperature and concentration profiles. This may then result in altered chemistry, thus adversely influencing productivity, selectivity, catalyst deactivation, and other performance metrics associated with the reactor. This leads to the performance of a large reactor being difficult to predict on the basis of the performance a small reactor. Extensive scale-up tests, reactor modeling, and basic reactor study are therefore typically required for the scale-up of new and/or existing chemical reactors, for new as well for existing chemical reactions.

Consequently, there exists a need for an improved method for scaling- up a chemical process and a process container that overcomes the aforementioned difficulties.

### SUMMARY

In accordance with some aspects of the disclosure, a process container and a method for scaling-up a chemical process is provided. The process container is used in a chemical process and has two planar faces that are parallel to each. The edges of the faces are joined together by adjacent curved bullnose portions.

In accordance with some aspects of the disclosure, a process of designing new process equipment components is provided. The process includes taking an existing process equipment component possessing symmetry about one axis, dividing it along a plane running through that axis, separating the two pieces produced in this dividing operation by a finite distance, and joining them with linear elements of similar profile.

In accordance with some aspects of the disclosure, a process of scaling up a chemical process operation from a small scale apparatus to a large scale unit is provided. The process includes the steps of maintaining the diameter of the small scale apparatus as a critical dimension; inserting a rectangularly cross-sectioned extension between two half-cylindrically shaped ends corresponding to halves of the apparatus.

### BRIEF DESCRIPTION OF THE DRAWINGS

FIG. 1 illustrates a perspective view of a process container according to an embodiment of the present invention.

FIG. 2A illustrates a perspective view of a process container that is nested according to an embodiment of the present invention.

FIG. 2B illustrates a cross-sectional view of the nested process container shown in FIG. 2A.

FIG. 3 illustrates a perspective view of a process container according to an embodiment of the present invention that is ring shaped with a stadium-form cross-sectional area.

FIG. 4 illustrates a perspective view of a process container according to an embodiment of the present invention showing an oblate form.

FIG. 5 illustrates a perspective view of a process container according to an embodiment of the present invention that has a serpentine form,

FIG. 6 illustrates a perspective view of a process container according to an embodiment of the present invention that has a conical bottom.

FIG. 7A illustrates a perspective view of a process container according to an embodiment of the present invention having a ball valve component.

FIG. 7B illustrates a cross-sectional view of a process container according to an embodiment of the present invention of process container in FIG. 7A.

FIG. 8 illustrates a perspective view of a process container according to an embodiment of the present invention that has a fluid educator or ejector.

FIG. 9A illustrates a perspective view of a process container according to an embodiment of the present invention having a spring check valve.

FIG. 9B illustrates a perspective view of the process container depicted in FIG. 9A where the valve is open.

FIG. 10 illustrates a perspective view of a process container according to an embodiment of the present invention having pairs of opposed screw conveyors.

FIG. 11 illustrates a perspective view of a chemical process using multiple process containers according to an embodiment of the present invention.

FIG. 12 illustrates a frontal view of process containers in series according to an embodiment of the present invention.

FIG. 13 illustrates a perspective view of process containers according to an embodiment of the present invention that are in nested perpendicular ribbon form.

FIG. 14A illustrates a perspective view of a process container according to an embodiment of the present invention having a conveyor bottom.

FIG. 14B illustrates an enlarged perspective view of the conveyor illustrated in FIG. 14A according to an embodiment of the present invention.

FIG. 15 illustrates a perspective view of a cassette furnace using process containers according to an embodiment of the present invention.

FIG. 16 illustrates a perspective view of a conventional process container having cylindrical geometry.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### DETAILED DESCRIPTION

A process container and method for scaling-up a chemical process are provided and described below.

Description of the Process Container

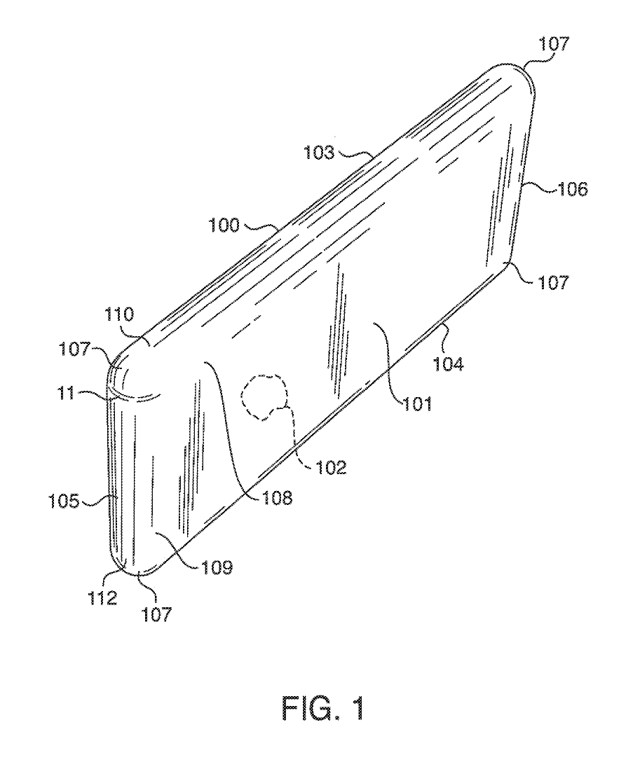

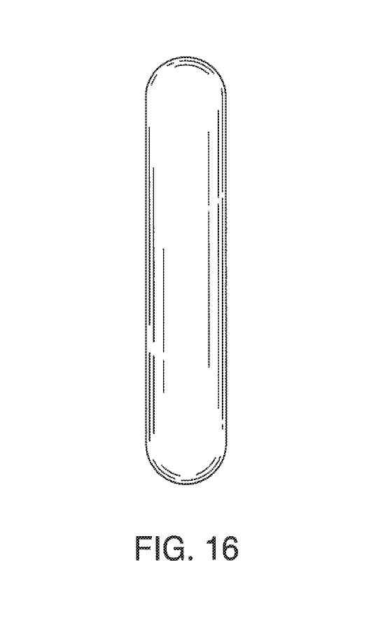

A conventional process container known in the prior art is shown in FIG. 16. As shown the conventional process container has a cylindrical shape. A process container according to an embodiment of the present disclosure is shown in FIG. 1. This process container does not have a cylindrical shape but rather has two planar surfaces that are parallel to each other, joined at their edges by half cylinders and at their corners by quarter spheres.

By abandoning the cylindrical geometry of FIG. 16 in favor of the modified superquadic geometry of FIG. 1, the process demonstrated on the small scale in the cylindrical container of FIG. 16 can be performed at larger scale without the deterioration in process performance attendant with scale-up to a larger scale version of FIG. 16. This is achieved using a scale-up rule for the modified superquadratic she in FIG. 1 which preserves either the characteristic length across which physical processes, e.g., heat transfer, must occur, or, alternately, preserving the ratio of surface area to volume of the smaller scale experiment performed in the cylindrical shell of FIG. 16.

The present, invention replaces the scale-up problem associated with cylindrically scaling up the container in FIG. 16 with a flow control problem of maintaining uniform flow along the axis of scale-up, into the page and toward the upper right in FIG. 1. As shown in FIG. 1, the process container for has two planar faces parallel to each other wherein the edges of the faces are joined together by adjacent curved bullnose portions. In some embodiments according to the present disclosure, the depth of the container is larger than the width of the bullnose portions.

The shape of the present invention process container may be described as a generalization of the shape known mathematically as a capsule. The geometry of the generalized capsule shape may be described using superellipsoidal, superquadratic, and superquadric terminology. The use of this geometry is fairly recent and its penetration into engineering has to date been limited to the field of image processing. The use of this geometry in the field of chemical processing represents a fundamental shift in paradigm for chemical process development and design professionals.

In one embodiment of the present invention, a container is provided that is suitable for carrying out operations of combining (including mixing) chemical species with a method of direct scale-up from laboratory experiments to commercial-scale operation.

In another embodiment of the present invention, a container is provided that is suitable for carrying out operations of reacting chemical species with a method of direct scale-up from laboratory experiments to commercial-scale operation, with residence time distributions approximating either mixed flow or plug flow ideal reactor types.

In yet another embodiment of the present invention, a container is provided with a reciprocating agitator featuring isotropic turbulence, that is suitable for carrying out operations of combining, reacting, and/or separating chemical species with a method of direct scale-up from laboratory experiments to commercial-scale operation.

In yet another embodiment of the present invention, a container is provided with a reciprocating fluid mover featuring unidirectional fluid motion on one side of a central baffle, providing for circulation around baffle, for mixed flow operation, that is suitable for carrying out operations of combining and/or reacting chemical species with a method of direct scale-up from laboratory experiments to commercial-scale operation.

In yet another embodiment of the present invention, a container is provided with a central inner container, providing for introduction of one or more reactants or treating agents in a cross-flow pattern which allows better control of local concentrations of chemical species to improve selectivity or yield, which is suitable for carrying out operations of combining and/or reacting chemical species with a method of direct scale-up from laboratory experiments to commercial-scale operation.

In yet another embodiment of the present invention, a container is provided with a central inner container, providing for selective removal of one or more chemical or by-product species in a cross-flow pattern which allows better control of local concentrations of chemical species to improve selectivity or yield, which is suitable for carrying out operations of reacting and/or separating chemical species with a method of direct scale-up from laboratory experiments to commercial-scale operation.

In yet another embodiment of the present invention, a container is provided in a ring configuration, to offer characteristics approaching those of an ideal mixed flow reactor, that is suitable far carrying out operations of combining and/or reacting chemical species with a method of direct scale-up from laboratory experiments to commercial-scale operation.

In yet another embodiment of the present invention, a container is provided with a pigging device, allowing the container to be swept clear of incrustations, provide compression and/or expansion cycles, provide size reduction of solid feedstock, intermediate, or final solid matter, or to be isolated into discrete lots of material, that is suitable for carrying out operations of combining and/or reacting chemical species with a method of direct scale-up from laboratory experiments to commercial-scale operation.

In yet another embodiment of the present invention, a container is provided with a ram device, allowing the container to be discharged, provide compression and/or expansion cycles, provide size reduction of solid feedstock, intermediate, or final solid matter, that is suitable for carrying out operations of reacting and/or separating chemical species with a method of direct scale-up from laboratory experiments to commercial-scale operation.

In yet another embodiment of the present invention, a container is provided with walls profiled to provide the cascading gas-solid contacting action that is suitable for carrying out operations of reacting, separating, or transferring heat to/from chemical species with a method of direct scale-up from laboratory experiments to commercial-scale operation.

In yet another embodiment of the present invention, a container is provided with walls profiled with, e.g., the riblet texture derived from patterns observed on the skins of fast-swimming sharks, or textures known to take advantage of the Coanda effect, to enhance surface renewal on process side and/or hot gas adherence to wall for transferring heat to/from chemical species, with a method of direct scale-up from laboratory experiments to commercial-scale operation.

In yet another embodiment of the present invention, a container is provided with geometry matching that of, e.g., bales of energy crops/agricultural waste or cords of cut and split firewood, and porous media false bottom/top/ends/faces to afford the fixed bed treatment of solid feedstocks with once-through or recirculated flow of gases or liquids in any of six directions, that is suitable for carrying out operations of reacting, separating, or transferring heat to/from chemical species with a method of direct scale-up from laboratory experiments to commercial-scale operation.

In yet another embodiment of the present invention, a plurality of containers is provided as individual retorts which process a variety feedstocks in a common furnace, using a variety of reactants or treating agents, for a variety of holding times, to produce a variety of products as extruded or pelletized solids, including dried, pretreated, torrefied, pyrolized, gasified, and combusted feedstocks, including, e,g., woods, energy crops, native prairie grasses, polyculture and monoculture agriculture residues, scrap tires, waste paper and cardboard, wood processing scrap, forestry residues, animal waste, anaerobic digestor sludge, municipal solid waste, construction and disaster cleanup spoils, etc., with a method of direct scale-up from laboratory experiments to commercial-scale operation.

In yet another embodiment of the present invention, a container is provided that is suitable for carrying out operations of separating chemical species with a method of direct scale-up from laboratory experiments to commercial-scale operation.

In yet another embodiment of the present invention, a container is provided that is suitable for carrying out operations of simultaneously reacting and separating chemical species with a method of direct scale-up from laboratory experiments to commercial-scale operation.

In yet another embodiment of the present invention, a plurality of stadium cross section tubes are arranged in between tubesheets in a container is provided that is suitable for the e transfer of heat between fluids and solids, in a new heat exchanger that is a hybrid of tube and plate types.

In yet another embodiment of the present invention, a container is provided with a reciprocating or rotating fluid mover featuring unidirectional fluid motion on one or both sides of a central baffle, providing pumping action that is suitable for carrying out operations of moving liquids, solids, or mixtures of both in commercial-scale operation.

In yet another embodiment of the present invention, a container is used for the holding or storage of chemical species in commercial-scale operation.

A vertical (or otherwise oriented) reactor chamber, produced from a squircular or stadium tube in the shape of a vertical prism of squircular or stadium cross-section, joined to top and bottom heads of semi-cylindrical cross-section, with ¼-ell half-pipe corner transitions is provided according to one embodiment of the present invention.

Reactor internal elements for catalysis, adsorption, etc., chosen from, e.g., monoliths, foam, mesh may be used. There may be a means of distributing the feed(s) to the reaction chamber. There may also be a means of providing desired level of mixing to feeds, e.g., impinging jet mixer.

The reactor may also include the following additional components or features according to various embodiments of the present invention: a means of collecting the product from opposite end of the reaction chamber, a means of preheating the feeds) to the reaction chamber, especially vertical plena similar in shape to the reaction chamber forming outer walls of furnace; a means to transfer heat from product exiting reaction chamber to feed(s), preferable in similar form factor to cross section of outer chamber; interconnecting piping or ductwork between internal feed heater plena and, and between reaction chamber and external feed preheater.

Feed supply and product transfer systems may be used with the container/reactor. It may also have a control system (feed, sequence, temperature, composition, heating system, startup/shutdown, etc., and process safety and environmental systems. There may be process Intensification internals for reaction chamber, preheaters, etc., e.g., fins, static mixer elements, baffles, etc., to improve heat transfer and mixing as appropriate.

The container/reactor operating mode may be chosen from among batch, continuous, semi-batch, semi-continuous, controlled-cycle, periodic, etc.

The flow pattern for the container/reactor may be chosen from among concurrent, cross-current, countercurrent, fixed-bed circulating/recycle, oscillatory, pulsed, separative, mixed, bubbling, slugging, explosive, etc. The heat transfer mode may be chosen from among direct, indirect, thermally coupled, heat pipe, ohmic, radiative, magnetocaloric, etc. External heat integration may be used.

The scale-up process according to one embodiment of the present invention is described below using the following steps:

1. Scale up a tubular flow reactor characterized by volumetrically determined performance by constant critical dimension:

1.1 Take an experiment performed in a cylindrical w reactor, of dimensions x1(=D, y1(=D), z1(=L).

1.2. Set D, Las critical dimensions.

1.3. Define (volumetric) scaleup factor SV.

1.4. Maintain D, L upon scaleup as follows:

1.4.1. Set dimension x2=x1=D.

1.4.2. Set dimension y2=(SV+4/π−1)·π·D/4.

1.4.3. Set dimension z2=z1=L.

2. Scale up a tubular flow reactor characterized by surface area determined performance by constant surface area to volume ratio:

2.1 Take an experiment performed in a cylindrical flow reactor, of dimensions x1(=D), y1(=D), z1(=L).

2.2. Set D, L as critical dimensions

2.3. Define (surface/volume) scaleup factor SA.

21.4. Maintain D, L upon scaleup as follows:

241.1. Set dimension x2=x1=D.

2.4.2. Set dimension y2=(π·SV·x1\hat{0}2+4·x2\hat{0}2−π·x2\hat{0}2)/(4·x\hat{0}2).

2.4.3. Set dimension z2=z1=L.

3. Scale up a batch or mixed flow reactor characterized by agitation determined performance by various scale-up rules, e.g., power per unit volume, blending time, agitator tip speed, agitator-induced flow, agitator-induced shear, etc.

3.1 Take an experiment performed in a cylindrical flow reactor, of dimensions x1(=D), y1(=D), z1(=L).

3.2. Define volumetric scale-up factor SV.

3.3. Construct scaled up process vessel of working volume equal to the product of small scale vessel working volume and scale-up factor SV in the form of a ring with non-cylindrical cross-section as described herein.

3.4. Set agitation level to correspond to that corresponding to scale-up rule chosen.

A process of designing new process equipment components may include the steps of: taking an existing process equipment component possessing symmetry about one axis, dividing it along a plane running through that axis, separating the two pieces produced in this dividing operation by a finite distance, and joining them with linear elements of similar profile.

The process of scaling up a chemical process operation from a small scale apparatus to a large scale unit may be performed by maintaining the diameter of the small scale apparatus as a critical dimension; and inserting a rectangularly cross-sectioned extension between two half-cylindrically shaped ends corresponding to halves of the apparatus. Alternatively, the process of scaling up a chemical process operation from a small scale apparatus to a large scale unit may be performed by maintaining the ratio of surface area of the small scale apparatus to its contained volume maintained as critical dimension; inserting a rectangularly cross-sectioned extension between two half-cylindrically shaped ends corresponding to halves an apparatus of with the aspect ratio of the two dimensions of the cross section perpendicular to the direction of normal flow.

A process of intensification of reaction or separation by a three- dimensional approach may feature flow or thermal intensification techniques along the direction of normal flow, volume-dependent intensification along one direction perpendicular to the direction of normal flow, or surface-area dependent along a second direction perpendicular to the direction of normal flow, in a manner that would tend to disrupt normal flow in conventional cylindrical process vessel geometry.

The process of thermal or mechanical integration of individual process reaction or separation steps may be performed by shaping the flow path in nested, layered, serpentine, and other patterns possible with planar channel geometry not possible with conventional cylindrical process vessels.

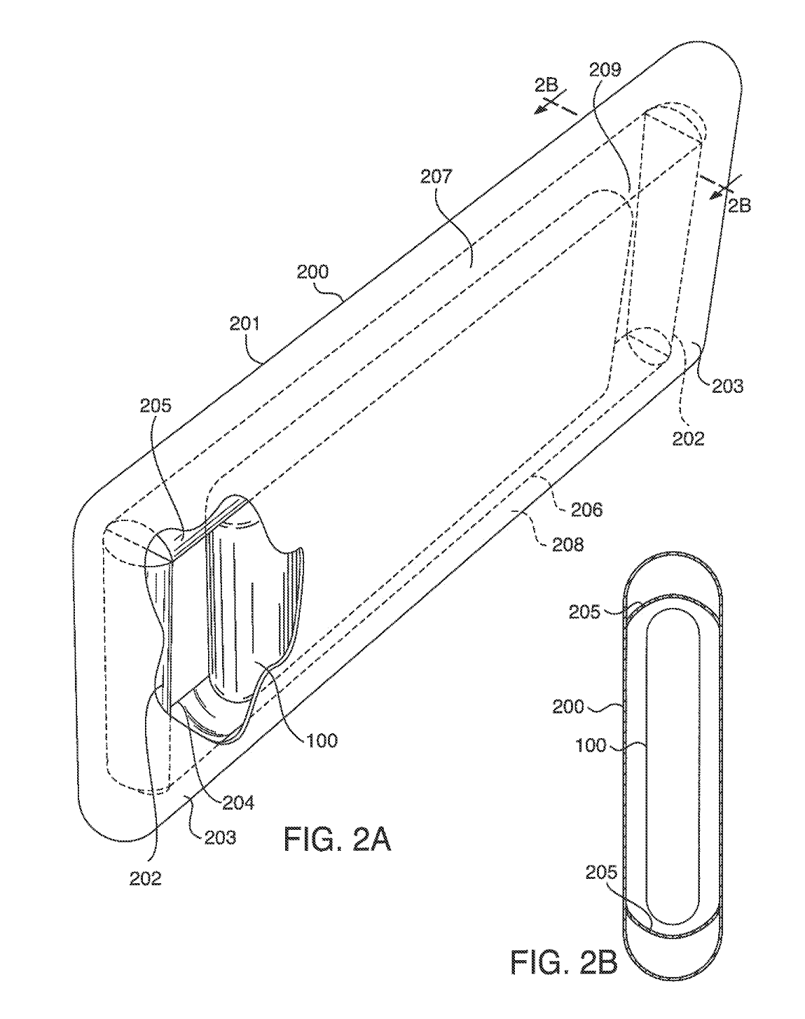

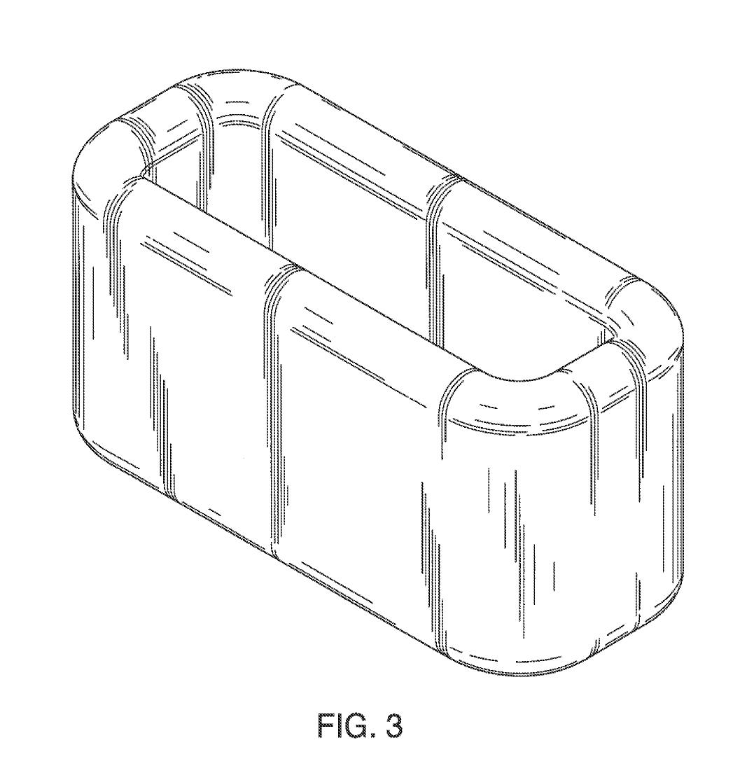

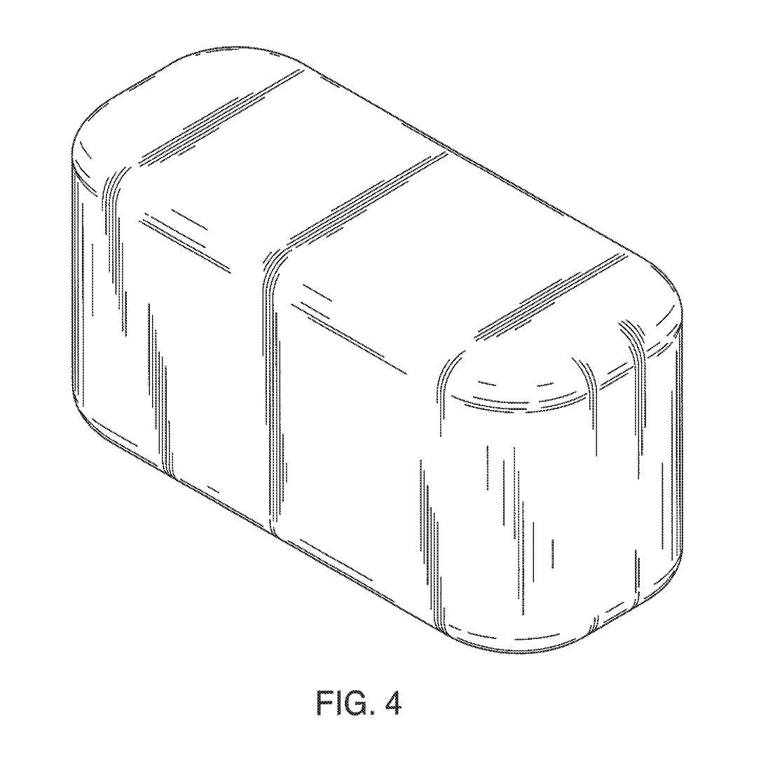

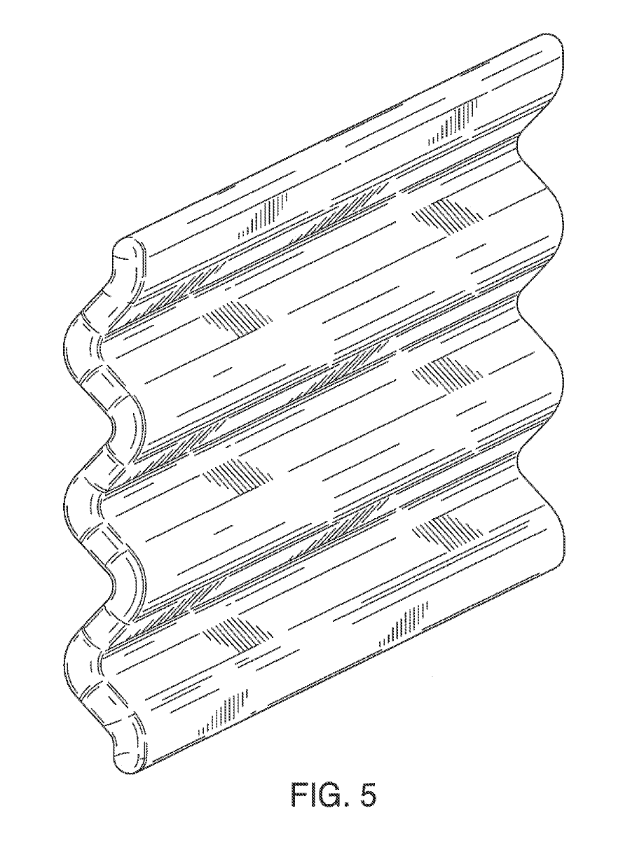

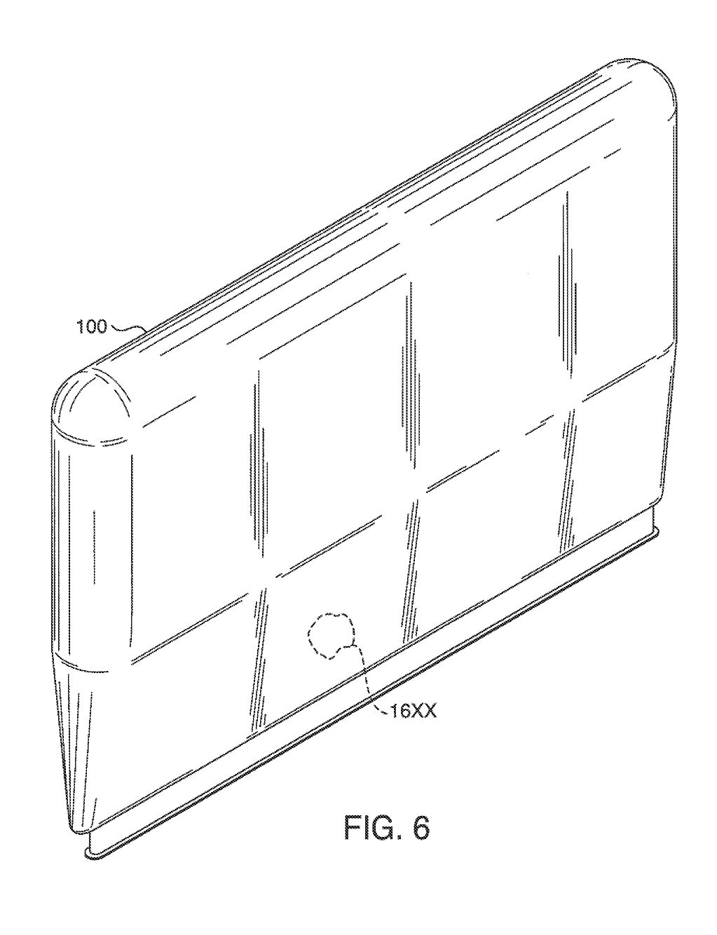

Using the scale-up process described above, scaled-up process containers having various geometries are may be formed. FIGS. 1-6 illustrate process containers having various geometries according to embodiments of the present invention. For example, as previously discussed, the process containers shown in FIGS. 1 and 2 have a superquadratic shape also described as the rectangular bullet shape. The process container in FIG. 3 is ring-shaped with a stadium-form cross-sectional area. The process container in FIG. 4 is an oblate form. The process container in FIG. 5 has a wavy or serpentine form. The process container in FIG. 6 has a conical bottom.

FIG. 6 depicts the rectangular bullet analog of a cylindroconical process vessel, with conical bottom generalized to a triangular prism. As illustrated, it features steeply sloped sides, corresponding to the design for mass flow hoppers for poorly flowing solids. The utility of this will be readily apparent to those who have struggled with the poorly behaving solids typical of renewable feedstock process operations.

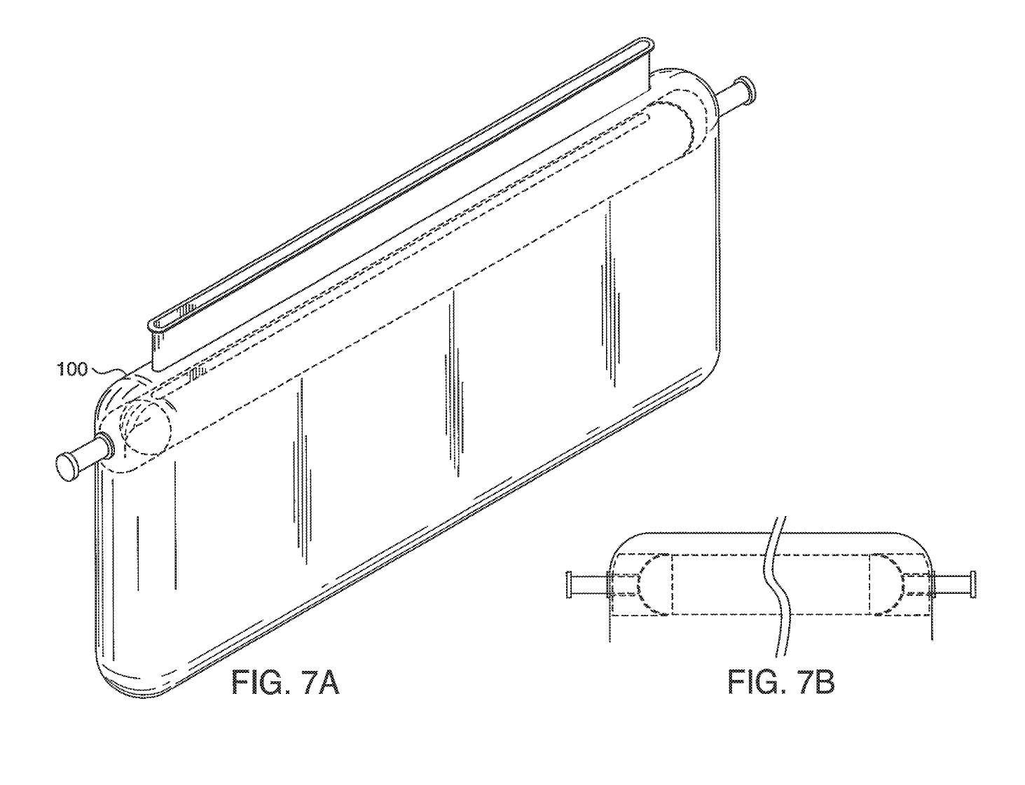

FIGS. 7-10 illustrate embodiments according to the present invention in which the process containers include additional components to assist in the chemical process. For example, FIGS. 7A and 7B illustrate how a ball valve possessing axisymmetry is generalized into a long axis capsular valve. It is intended as a component in any of the rectangular bullet, ringform, and ribbonform process vessel geometries depicted herein. This utility in constructing process plants from these geometries is inestimable. FIGS. 7A illustrates a perspective view of the process having a ball valve component. FIG. 7B illustrates a cross-sectional view of a process container according to an embodiment of the present invention of process container in FIG. 7A.

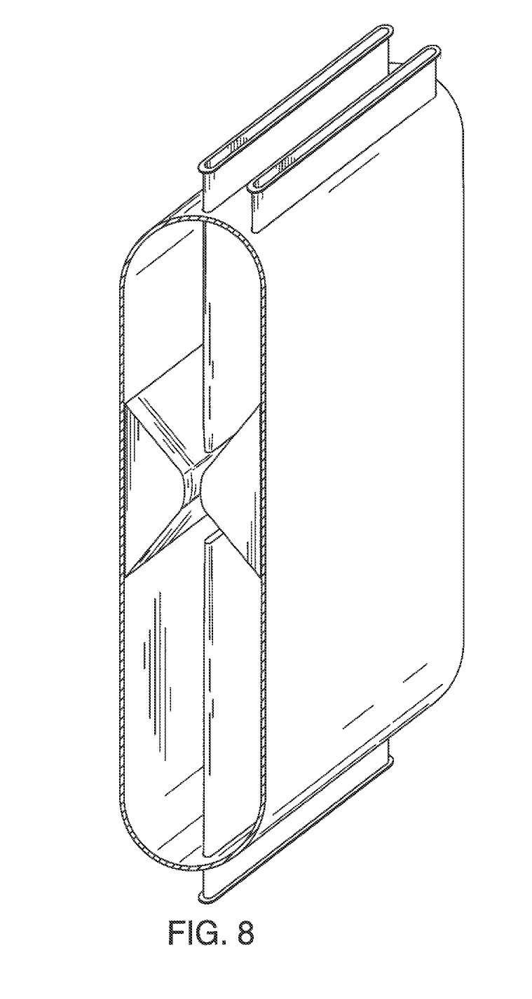

FIG. 8 illustrates a perspective view of a process container according to an embodiment of the present invention that has a fluid eductor or ejector. FIG. 8 shows a rectangular generalization of a fluid eductor or ejector, for use as a component in the rectangular bullet or ring vessel geometries depicted in earlier figures. It can be used as a scalable mixing or fluid moving device.

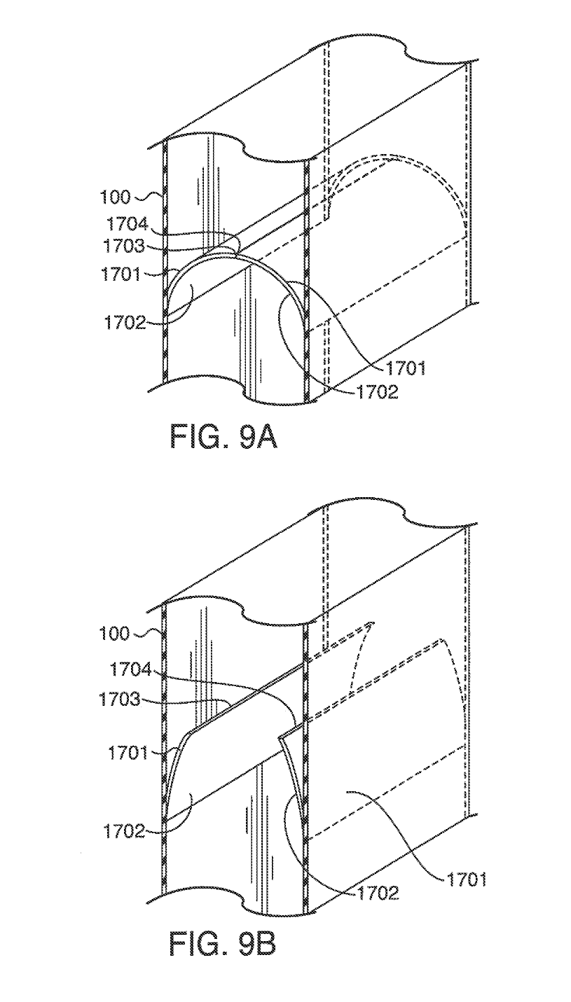

FIGS. 9A and 9B illustrate a possible method of producing a spring check valve using a principle that today's cylindrical paradigm does not allow. It is intended as a component in any of the rectangular bullet, ringform, and ribbonform process vessel geometries depicted herein. FIG. 9A illustrates a perspective view of a process container according to an embodiment of the present invention having a spring check valve that is closed, FIG. 9B illustrates a perspective view of the process container depicted in FIG. 9A where the valve is open.

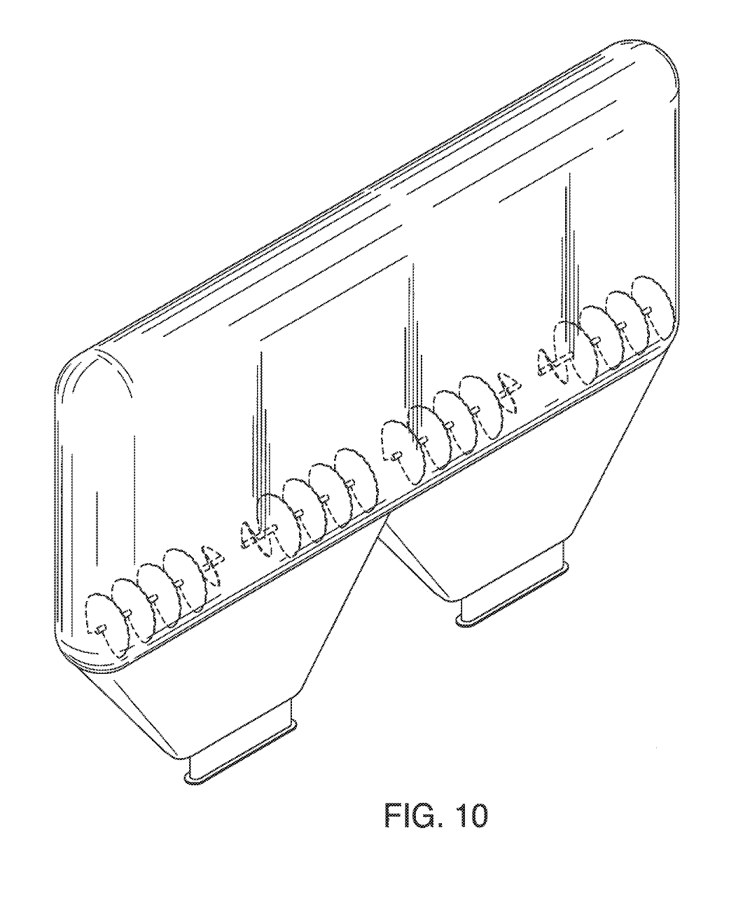

FIG. 10 illustrates a perspective view of a process container according an embodiment of the present invention having pairs of opposed screw conveyors. A rectangular bullet process vessel is shown arranged with pairs of opposed screw conveyors to discharge processed solids in a manner to minimize short circuiting and dead spots associated with a single screw.

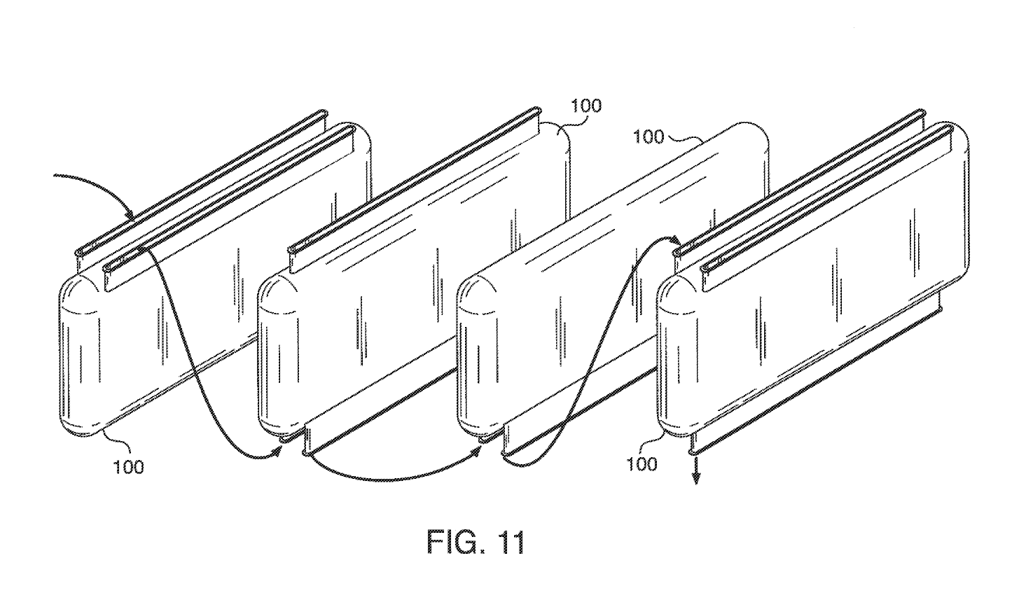

FIG. 11 illustrates a perspective view of a chemical process using multiple process containers according to an embodiment of the present invention. FIG. 11 illustrates how a basic rectangular bullet vessel would be deployed with internal vertical baffling for duplex up/down flow arrangements and integrated in a process consisting of 2 reaction steps with a separation following each. An example of such a process scheme from renewable fuels would be selective oxidation of methane from biogas into methanol and water, with separation of by-product water, followed by reaction of methanol to dimethyl ether, and purification of DME to vehicular fuel specifications.

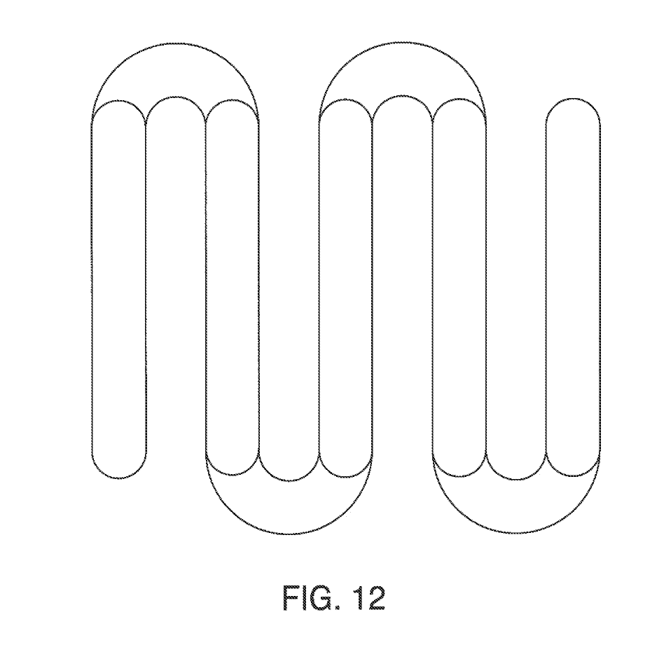

FIG. 12 illustrates a frontal view of process containers in series according to an embodiment of the present invention. FIG. 12 depicts a serpentine ribbonform approach to connecting multiple rectangular bullet vessels in series. The utility this offers integrated process operations that is unparalleled in today's cylindrical vessel landscape.

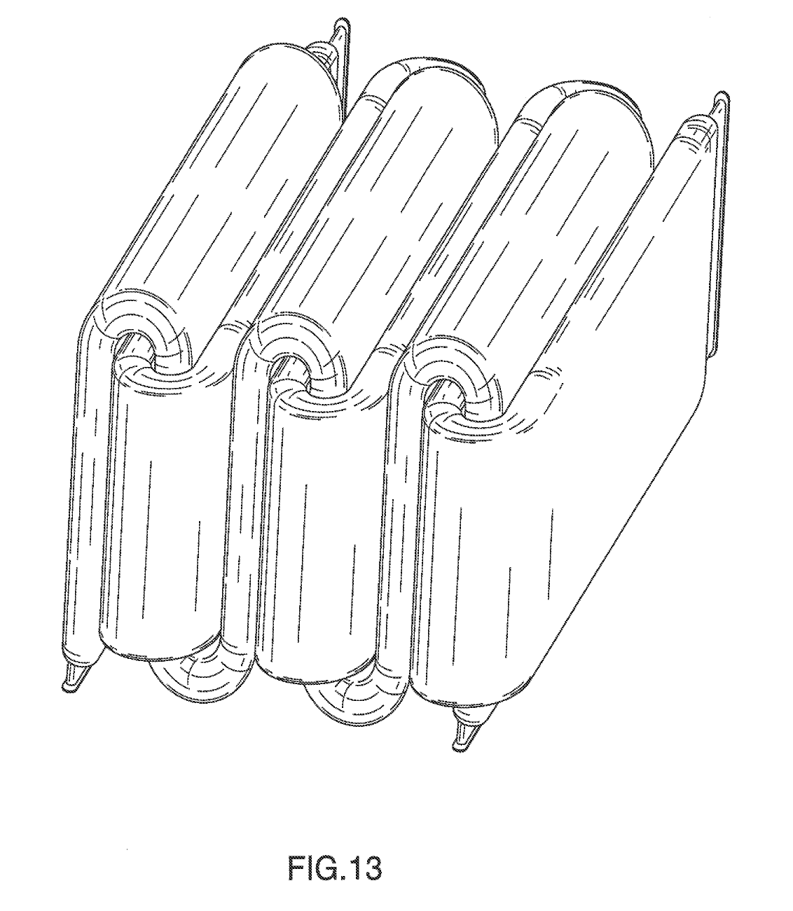

FIG. 13 illustrates a perspective view of process containers according to an embodiment of the present invention that are in nested perpendicular ribbon form. FIG. 13 depicts serpentine ribbonform rectangular bullet process vessels in series tightly integrated with a serpentine ribbonform utility chase body. The spatial utilization possibilities of this approach for the process industries are endless.

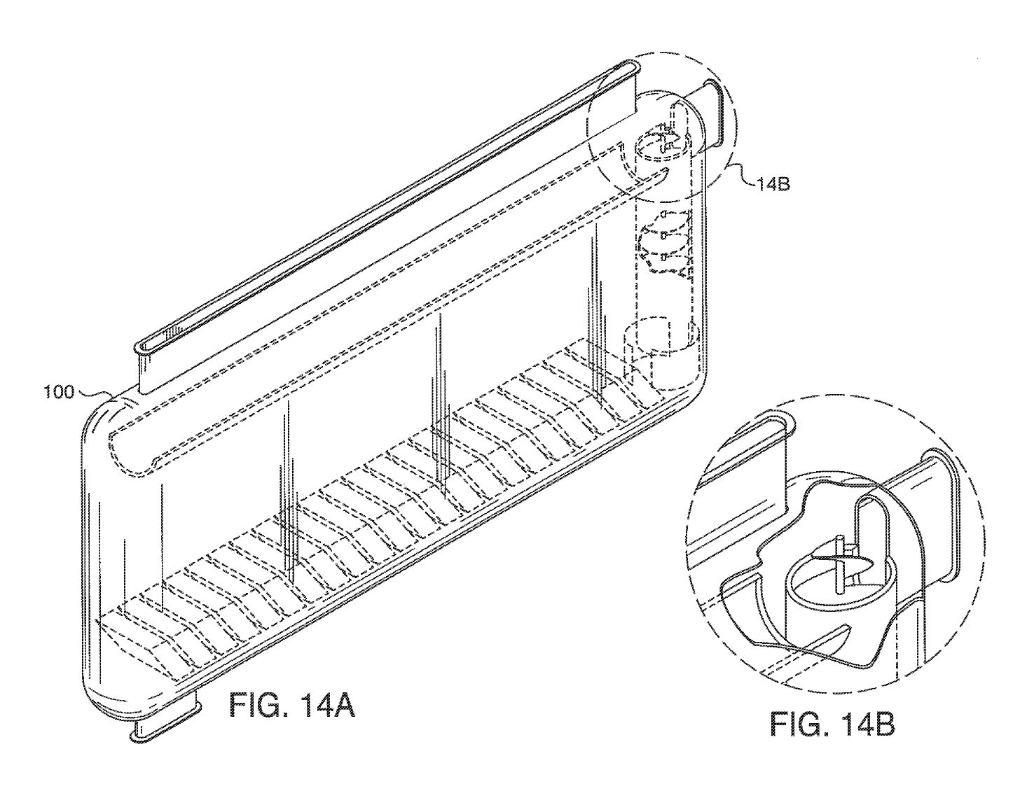

FIG. 14A illustrates a perspective view of a process container according to an embodiment of the present invention having a conveyor bottom. FIG. 14B illustrates an enlarged perspective view of the conveyor illustrated in FIG. 14A according to an embodiment of the present invention. These figures depicts an embodiment featuring a slot deck solids conveyor at the bottom, and an olds elevator for processed solids discharge. This arrangement offers, for example, a means of conducting fluidized bed catalytic cracking reactions in a flow pattern closer to plug flow than today's state of the art mixed flow operation, with obvious advantages.

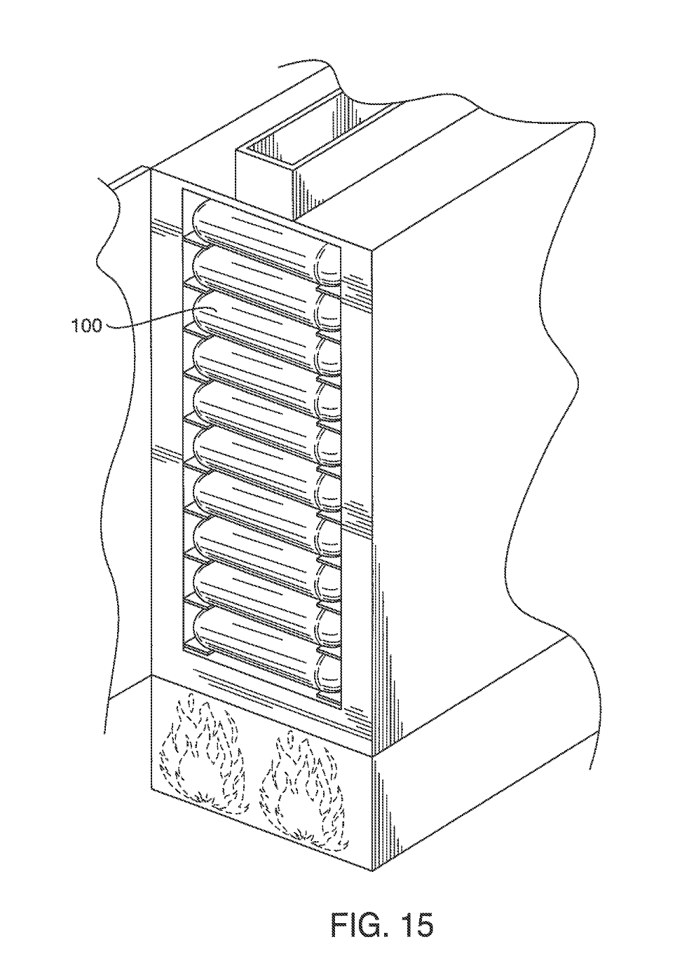

FIG. 15 illustrates a cassette furnace application featuring rectangular bullet retorts. A temperature gradient from firebox to flue offers the possibility of treating a variety of feedstocks at a variety of conditions depending on feedstock mix available and product mix desired from thermal treatment of renewable feedstocks. Serpentine ribbonform (resembling ribbon candy) flue gas channels intertwined between retort vessels offers superior recuperative thermal integration. Sealed containers as shown could be handled with tray loading/unloading robotics for batch recipe management. Retort docking systems could be used to offer cross-flow and counter-flow interactions of gases produced by one process with the solids of another.

Additional features, advantages, and aspects of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

What is claimed is:

1. A process container for use in a chemical process comprising two planar s parallel to each other wherein the edges of the faces are joined together by adjacent curved bullnose portions.

2. The process container of claim 1 wherein the planar surfaces are square or rectangle.

3. The process container of claim 1 wherein the container is used to hold gas, liquid, solid or mixtures thereof under pressure.

4. The process container of claim 1 further comprising an outer chamber surrounding the outer surface of the container wherein a supply of cooling fluid passes through the outer chamber to cool the process container.

5. The process container of claim 1 further comprising an outer chamber surrounding the outer surface of the container wherein a supply of heating passes through the outer eh amber to heat the process container.

6. The process container of claim 1 wherein the process container is used as a reactor.

7. The process container of aim 1 wherein the process container has an oblong ductwork cross-section.

8. The process container of claim 1 wherein the process container has a ring-shaped form of one of various non-circular cross-sectional shapes.

9. The process container of claim 1 wherein the depth of the container is larger than the width of the bullnose portions.

10. The process of designing new process equipment components comprising the steps of: taking an existing process equipment component possessing symmetry about one axis, dividing it along a plane running through that axis, separating the two pieces produced in this dividing operation by a finite distance, and joining them with linear elements of similar profile.

11. The process of scaling up a chemical process operation from a small scale apparatus to a large scale unit comprising the steps of: maintaining the diameter of the small scale apparatus critical dimension; inserting a rectangularly cross-sectioned extension between two half-cylindrically shaped ends corresponding to halves of the apparatus.

12. The process of scaling up a chemical process operation from a small scale apparatus to a large scale unit comprising the steps of: maintaining the ratio of surface area of the small scale apparatus to its contained volume maintained as critical dimension; inserting a rectangularly cross-sectioned extension between two half-cylindrically shaped ends corresponding to halves an apparatus of with the aspect ratio of the two dimensions of the cross section perpendicular to the direction of normal flow.

13. The process of intensification of reaction or separation processes by a three-dimensional approach featuring flow or thermal intensification techniques along the direction of normal flow, volume-dependent intensification along one direction perpendicular to the direction of normal flow, or surface-area dependent along a second direction perpendicular to the direction of normal flow, in a manner that would tend to disrupt normal flow in conventional cylindrical process vessel geometry.

14. The process of thermal or mechanical integration of individual process reaction or separation steps by shaping the flow path in nested, layered, serpentine, and other patterns possible with planar channel geometry not possible with conventional cylindrical process vessels.
